(19) United States
(12) Patent Application Publication
(10) Pub. No.: US 2024/0209270 A1
(43) Pub. Date: Jun. 27, 2024

(54) Process for Producing Jet Fuel from Isomerization and Hydrocracking

(71) Applicant: UOP LLC, Des Plaines, IL (US)

(72) Inventors: Neeraj TIWARI, Gurgaon (IN); James T. WEXLER, Wheaton, IL (US); Pallab BAKSHI, Kamrup (IN)

(21) Appl. No.: 18/243,534

(22) Filed: Sep. 7, 2023

Related U.S. Application Data
(60) Provisional application No. 63/404,525, filed on Sep. 7, 2022.

(51) Int. Cl. C10G 65/12

(52) U.S. Cl. CPC C10G 65/12; C10G 2400/08

(57) ABSTRACT

A process isolates a liquid hydrocracked stream from a liquid hydroisomerized stream, so heat in the hydrocracked stream can be preserved. Preserving heat in the hydrocracked stream avoids having to reheat the hydrocracked stream before product fractionation. Particularly, kerosene in the hydrocracked stream is not cooled with the hydroisomerized stream and then reheated in fractionation to distill the kerosene range hydrocarbons from the diesel range hydrocarbons.

### FIELD

The field is producing hydrocarbons useful as aviation fuel from a hydrocarbon feedstock. Particularly, the field may relate to producing aviation fuel from renewable feedstocks such as triglycerides and free fatty acids found in materials such as plant and animal fats and oils.

### BACKGROUND

As the demand for fuel increases worldwide, there is increasing interest in producing fuels and blending components from sources other than crude oil. Often referred to as a biorenewable source, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA). Both triglycerides and the FFAs contain aliphatic carbon chains having from about 8 to about 24 carbon atoms. The aliphatic carbon chains in triglycerides or FFAs can be fully saturated, or mono, di or poly-unsaturated.

Hydroprocessing can include processes which convert hydrocarbons in the presence of hydroprocessing catalyst and hydrogen to more valuable products. Hydrotreating is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

The production of hydrocarbon products in the diesel boiling range can be achieved by hydrotreating a biorenewable feedstock. A biorenewable feedstock can be hydroprocessed by hydrotreating to deoxygenate, decarboxylate and/or decarbonylate the oxygenated hydrocarbons. Decarboxylation and decarbonylation remove a carbon from the paraffin molecule; whereas, deoxygenation does not. Hydrotreating may be followed by hydroisomerization to improve cold flow properties of product diesel and jet fuel. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

Hydrocracking is a hydroprocessing process in which hydrocarbons crack in the presence of hydrogen and hydrocracking catalyst to lower molecular weight hydrocarbons. Depending on the desired output, a hydrocracking unit may contain one or more beds of the same or different catalyst.

When producing jet fuel from triglycerides (also referred to as “fats”) a certain degree of hydrocracking and isomerization is needed to meet the specifications of jet fuel as outlined in ASTM D7566 Annex 2 and ASTM D1655. These key specifications that are required of the jet fuel in D7566 are freeze point of not higher than −40° C. (ASTM D5972, D7153 or D7154), density of no more than 772 kg/m³ (ASTM D1298 or D4052), T10 of less than 205° C. (ASTM D86), and a final boiling point (FBP) of less than 300° C. (ASTM D86). Larger molecules that do not meet these jet fuel specifications are hydrocracked primarily to meet these specifications which inherently results in low yield in the production process and in a low energy-density fuel which is undesirable. Aviation fuel is valued for its high energy per volume.

Carbon intensity is a term that refers to moles of carbon dioxide produced to make a mole of fuel. Combustion of hydrocarbons such as to heat hydrocarbons streams in a hydroprocessing unit increases carbon intensity. It would be desirable to provide a renewable fuel from a process that reduces carbon intensity by reducing heating requirements.

### SUMMARY

We have found that by isolating a liquid hydrocracked stream from a liquid hydroisomerized stream, heat in the hydrocracked stream can be preserved. Preserving heat in the hydrocracked stream avoids reheating the hydrocracked stream before product fractionation. Particularly, kerosene in the hydrocracked stream is not cooled with the hydroisomerized stream and then reheated in fractionation to distill the kerosene range hydrocarbons from the diesel range hydrocarbons.

### BRIEF DESCRIPTION OF THE DRAWINGS

FIG. 1 is a schematic process flow diagram of the present disclosure.

FIG. 2 is a schematic process flow diagram of an alternative embodiment of FIG. 1.

FIG. 3 is a schematic process flow diagram of another alternative embodiment of FIG. 1.

FIG. 4 is a schematic process flow diagram of a further embodiment of FIG. 1.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D86 or ASTM D2887.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5” or “T95” means the temperature at which 5 mass percent or 95 mass percent, as the case may be, respectively, of the sample boils using ASTM D-86 or TBP.

As used herein, the term “initial boiling point” (IBP) means the temperature at which the sample begins to boil using ASTM D2887, ASTM D-86 or TBP, as the case may be.

As used herein, the term “final boiling point” (FBP) means the temperature at which the sample has all boiled off using ASTM D2887, ASTM D-86 or TBP, as the case may be.

As used herein, the term “diesel boiling range” means hydrocarbons boiling in the range of an IBP between about 125° C. (257° F.) and about 175° C. (347° F.) or a T5 between about 150° C. (302° F.) and about 200° C. (392° F.) and the “diesel cut point” comprising a T95 between about 343° C. (650° F.) and about 399° C. (750° F.) using the TBP distillation method.

As used herein, the term “diesel conversion” means conversion of feed that boils above the diesel cut point to material that boils at or below the diesel cut point in the diesel boiling range.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” are to be understood to refer to molecules having the number of carbon atoms represented by the subscript “x”. Similarly, the term “Cₓ−” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

### DETAILED DESCRIPTION

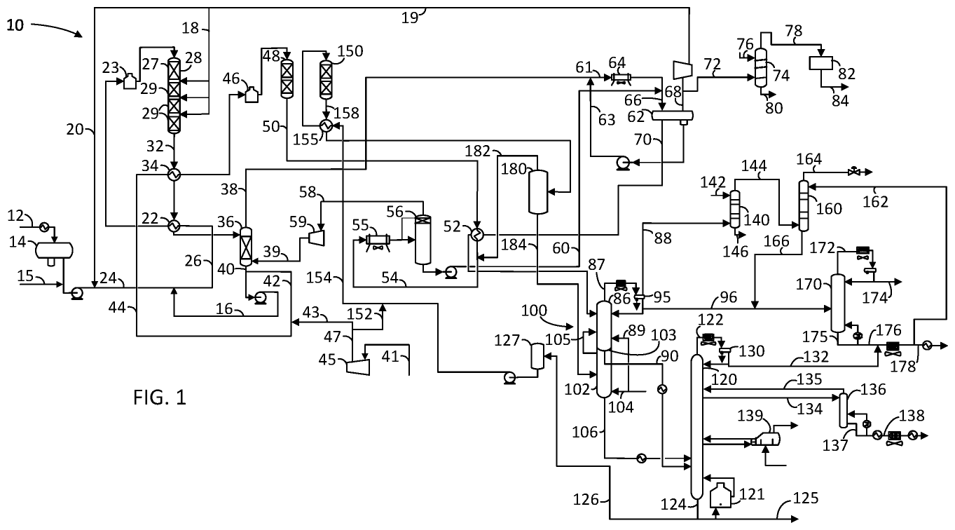

In FIG. 1, in accordance with an exemplary embodiment, a process 10 is shown for processing a hydrocarbon feedstock. Preferably, the hydrocarbon feedstock is a biorenewable hydrocarbon feedstock. A feed line 12 transports a hydrocarbon stream of fresh biorenewable feedstock into a feed surge drum 14. The biorenewable feedstock may be blended with a mineral feed stream but preferably comprises a predominance of biorenewable feedstock. A mineral feedstock is a conventional feed derived from crude oil that is extracted from the ground. The biorenewable feedstock may comprise a nitrogen concentration of about 50 wppm to about 2000 wppm. The biorenewable feedstock may comprise high oxygen content which can be up to 10 wt % or higher. The biorenewable feedstock may also comprise about 1 to about 500 wppm sulfur, typically no more than about 200 wppm sulfur.

A variety of different biorenewable feedstocks may be suitable for the process 10. The term “biorenewable feedstock” is meant to include feedstocks other than those obtained from crude oil. The biorenewable feedstock may include any of those feedstocks which comprise at least one of glycerides and free fatty acids. Most of glycerides will be triglycerides, but monoglycerides and diglycerides may be present and processed as well. Free fatty acids may be obtained from phospholipids which may source phosphorous in the feedstock. Examples of these biorenewable feedstocks include, but are not limited to, camelina oil, canola oil, corn oil, soy oil, rapeseed oil, soybean oil, colza oil, tall oil, sunflower oil, hempseed oil, olive oil, linseed oil, coconut oil, babassu oil, castor oil, peanut oil, palm oil, mustard oil, tallow, yellow and brown greases, lard, train oil, fats in milk, fish oil, algal oil, sewage sludge, and the like. Additional examples of biorenewable feedstocks include non-edible vegetable oils from the group comprising Jatropha curcas (Ratanjot, Wild Castor, Jangli Erandi), Madhuca indica (Mohuwa), Pongamia pinnata (Karanji, Honge), Calophyllum inophyllum, Moringa oleifera and Azadirachta indica (Neem). The triglycerides and FFAs of the typical vegetable or animal fat contain aliphatic hydrocarbon chains in their structure which have about 8 to about 30 carbon atoms. Biorenewable feedstocks may also include biomass pyrolysis oils and Fischer-Tropsch waxes. As will be appreciated, the biorenewable feedstock may comprise a mixture of one or more of the foregoing examples. The biorenewable feedstock may be pretreated to remove contaminants and filtered to remove solids.

The hydrocarbon stream in feed line 12 flows from the feed surge drum 14 via a charge pump perhaps after injection with a sulfiding agent in line 15 and mixes with a recycle hydrotreating hydrogen stream in a hydrotreating hydrogen line 20 to provide a combined hydrocarbon stream in line 24. The combined hydrocarbon stream in line 24 is mixed with a hydrotreating recycle stream in a recycle line 16 to provide a hydrotreating charge hydrocarbon stream in a hydrotreating charge line 26. The recycle to feed rate can be about 1:1 to about 5:1. The hydrotreating charge hydrocarbon stream in line 26 may be preheated in a combined feed exchanger 22 by heat exchange with a hydrotreated stream in a hydrotreated line 32 and perhaps then in a fired heater 23. The heated hydrotreating charge hydrocarbon stream in the hydrotreating charge line 26 may be then charged to a hydrotreating reactor 28.

The hydrotreating reactor 28 may include a guard bed reactor or a guard bed 27. In FIG. 1, the hydrotreating reactor 28 includes a guard bed 27. The guard bed reaction temperature may range between about 246° C. (475° F.) and about 343° C. (650° F.) and suitably between about 288° C. (550° F.) and about 304° C. (580° F.). Reaction temperature is operated low enough to prevent olefins in the FFA from polymerizing but high enough to foster olefin saturation, hydrodemetallation, hydrodeoxygenation, hydrodesulfurization and hydrodenitrification reactions to occur. Hydrodeoxygenation reactions preferably minimize hydrodecarbonylation and hydrodecarboxylation reactions to preserve carbon atoms on the paraffin chain.

The guard bed 27 can comprise a base metal catalyst on a support. Base metals useable in this process include non-noble metals, nickel, chromium, molybdenum and tungsten. Other base metals that can be used include tin, indium, germanium, lead, cobalt, gallium and zinc. The process can also use a metal sulfide, wherein the metal in the metal sulfide is selected from one or more of the base metals listed. The hydrotreating charge stream can be charged through the base metal catalysts at pressures from 1379 kPa (abs) (200 psia) to 13790 kPa (abs) (2000 psia). In a further embodiment, the guard bed catalyst can comprise a second metal, wherein the second metal includes one or more of the metals: tin, indium, ruthenium, rhodium, rhenium, osmium, iridium, germanium, lead, cobalt, gallium, zinc and thallium. A nickel molybdenum on alumina catalyst may be a suitable catalyst in the guard bed 27. Although only one guard bed is shown in FIG. 1, multiple guard beds may be contained in the hydrotreating reactor 28 such as 2, 3 or more and a hydrogen quench from a hydrogen manifold 18 may be injected at interbed locations to control temperature exotherms.

A contacted hydrocarbon stream is discharged from the guard bed 27. In the guard bed 27, most of the hydrodemetallation and hydrodeoxygenation reactions will occur with some hydrodenitrogenation and hydrodesulfurization occurring. Metals removed from biorenewable feedstocks will include alkali metals and alkali earth metals and phosphorous. If the guard bed has a dedicated reactor vessel, the contacted hydrocarbon stream will discharge from the guard bed reactor. However, in FIG. 1, the guard bed 27 is contained in a hydrotreating reactor 28, so the contacted stream will receive a hydrogen quench from hydrogen manifold 18 and enter into a hydrotreating catalyst bed 29.

In the hydrotreating reactor 28, the contacted hydrocarbon stream is contacted with a hydrotreating catalyst in the hydrotreating catalyst bed 29 in the presence of hydrogen at hydrotreating conditions to saturate the olefinic or unsaturated portions of the n-paraffinic chains in the biorenewable feedstock. The hydrotreating catalyst also catalyzes hydrodeoxygenation reactions, including hydrodecarboxylation and hydrodecarbonylation reactions, to remove oxygenate functional groups from the hydrocarbon molecules in the biorenewable feedstock which are converted to water and carbon oxides. The hydrotreating catalyst also catalyzes hydrodesulfurization of organic sulfur and hydrodenitrogenation of organic nitrogen in the biorenewable feedstock. Essentially, the hydrotreating reaction removes heteroatoms from the hydrocarbons and saturates olefins in the feed stream.

The hydrotreating catalyst may be provided in one, two or more beds and employ interbed hydrogen quench streams from the hydrogen quench stream. Recycle hydrogen quench streams taken from the recycle hydrogen line 19 in a hydrogen manifold line 18 may be provided for interbed quench to the hydrotreating reactor 28. Three hydrotreating catalyst beds 29 are shown in FIG. 1, but one or more are contemplated.

The hydrotreating catalyst may comprise nickel, nickel/molybdenum, or cobalt/molybdenum dispersed on a high surface area support such as alumina. Other catalysts include one or more noble metals dispersed on a high surface area support. Non-limiting examples of noble metals include platinum and/or palladium dispersed on an alumina support such as gamma-alumina. Suitable hydrotreating catalysts include BDO 200 or BDO 300 or BDO 400 available from UOP LLC in Des Plaines, Illinois. The hydrotreating reaction temperature may range from between about 271° C. (520° F.) and about 427° C. (800° F.) and preferably between about 304° C. (580° F.) and about 400° C. (752° F.). Generally, hydrotreating conditions include a pressure of about 700 kPa (100 psig) to about 21 MPa (3000 psig).

A hydrotreated stream is produced in a hydrotreated line 32 from the hydrotreating reactor 28 comprising a hydrocarbon fraction which has a substantial n-paraffin concentration. Oxygenate concentration in the hydrocarbon fraction is essentially nil, whereas the olefin concentration is substantially reduced relative to the contacted biorenewable feed stream. The organic sulfur concentration in the hydrocarbon fraction is no more than 500 wppm and the organic nitrogen concentration in the hydrocarbon fraction is less than 10 wppm.

The hydrotreated stream in the hydrotreated line 32 may first flow to the combined isomerization feed exchanger 34 to heat the hydroisomerization feed stream in the hydroisomerization feed line 44 and cool the hydrotreated stream. As previously described, the cooled hydrotreated stream in the hydrotreated line 32 may then be heat exchanged with the combined hydrocarbon stream in line 24 in the combined feed heat exchanger 22 to further cool the cooled hydrotreated stream in the hydrotreated line 32 and heat the hydrotreating charge hydrocarbon stream in the hydrotreated line 32. The twice cooled hydrotreated steam in the hydrotreated line 32 may be then further cooled in the combined feed exchanger 22 by heat exchange with combined hydrocarbon stream in the combined feed line 24 to heat the combined hydrocarbon stream and cool the hydrotreated stream in the hydrotreated line 32. The twice cooled hydrotreated stream may be even further cooled, perhaps to make steam, before it is separated.

The cooled hydrotreated stream may be separated in a hydrotreating separator 36 which may comprise an enhanced hot separator (EHS) with the aid of a stripping gas fed in a stripping line 39 taken from an isomerization overhead line 58. The hydrotreated stream is separated to provide a hydrotreated vapor stream in a hydrotreated overhead line 38 and a hydrotreated liquid stream in a hydrotreated bottoms line 40 having a smaller oxygen concentration than the hydrotreating charge hydrocarbon stream in line 26. The hydrotreating separator 36 may be a high-pressure stripping column. In the hydrotreating separator 36, the hydrotreated stream from the hydrotreated line 32 flows down through the column where it is partially stripped of hydrogen, carbon dioxide, carbon monoxide, water vapor, propane, hydrogen sulfide, and phosphine, which are potential isomerization catalyst poisons, by contact with stripping gas from the stripping line 39. The stripping gas may comprise makeup hydrogen gas which has passed through the isomerization reactor 48 and an isomerization separator 56 as hereinafter described.

The stripping gas in the stripping line 39 enters the hydrotreating separator 36 below the inlet for the hydrotreated stream in the hydrotreated line 32. The hydrotreating separator 36 may include internals such as trays or packing located between the inlet for the hydrotreated stream in line 32 and the inlet for the stripping gas in the stripping line 39 to facilitate stripping of the hydrotreated stream. The stripping gas including stripped gases exit in a hydrotreated vapor stream in the hydrotreated overhead line 38 extending from a top of the hydrotreating separator 36 mixes with a cold aqueous stream in a cold aqueous line 63 from a boot of a cold separator 62 is cooled and mixes with an isomerization liquid stream in an isomerization bottoms line 60 and enters a cold separator 62.

The hydrotreating separator 36 operates at about 177° C. (350° F.) to about 371° C. (700° F.) and preferably operates at about 232° C. (450° F.) to about 315° C. (600° F.). The hydrotreating separator 36 may be operated at a slightly lower pressure than the hydrotreating reactor 28 accounting for pressure drop through intervening equipment. The hydrotreating separator 36 may be operated at pressures between about 3.4 MPa (gauge) (493 psig) and about 20.4 MPa (gauge) (2959 psig). The hydrotreated vapor stream in the hydrotreating separator overhead line 38 may have a temperature of the operating temperature of the hydrotreating separator 36.

The hydrotreated liquid stream which may have been stripped collects in the bottom of the hydrotreating separator 36 and flows in a hydrotreated bottoms line 40. The liquid hydrotreated stream comprises diesel range material, with a high paraffinic concentration if the hydrocarbon feed comprises a biorenewable feedstock. The liquid hydrotreated stream in the hydrotreating separator bottoms line 40 may be split into two streams: a hydroisomerization charge stream taken in a hydroisomerization charge line 42 and the recycle hydrotreated stream taken in the recycle line 16 both taken from the liquid hydrotreated stream in the hydrotreated bottoms line 40. The recycle hydrotreated stream in the recycle line 16 may be pumped and combined with the combined hydrocarbon stream in line 24 as previously described.

While a desired product, such as a transportation fuel, may be provided in the hydrotreated bottoms line 40 because the liquid hydrotreated stream comprises a higher concentration of normal paraffins, it will possess poor cold flow properties and high FBP disqualifying it from meeting jet fuel specifications. Accordingly, to improve the cold flow properties and reduce FBP, the hydrotreated liquid stream may be hydroisomerized.

Make-up hydrogen gas in make-up line 41 may be compressed in a make-up gas compressor 45 to provide compressed make up gas in a compressed make-up gas header 47. A hydroisomerization make-up gas stream is taken from the make-up gas header 47 in line 43 and mixed with the hydroisomerization charge stream in line 42 to provide a combined hydroisomerization charge stream in the combined hydroisomerization charge line 44. The combined hydroisomerization charge stream in the combined hydroisomerization charge line 44 may be heated in an hydroisomerization feed exchanger 34 by heat exchange with the hydrotreated stream in the hydrotreated line 32. The combined hydroisomerization charge stream may be heated in a hydroisomerization charge heater 46 to bring the combined hydroisomerization charge stream to hydroisomerization temperature before charging the combined hydroisomerization charge stream to the hydroisomerization reactor 48.

Hydroisomerization, including hydrodewaxing, of the normal hydrocarbons in the hydroisomerization reactor 48 can be accomplished over one or more beds of hydroisomerization catalyst, and the hydroisomerization may be operated in a co-current mode of operation. Fixed bed, trickle bed down-flow or fixed bed liquid filled up-flow modes are both suitable.

The hydroisomerization catalyst comprises a dehydrogenation metal, a molecular sieve and a metal oxide binder. The hydroisomerization catalyst may comprise a dehydrogenation metal comprising a Group VIII metal. The dehydrogenation metal(s) may be selected from platinum, palladium, nickel, nickel molybdenum sulfide or nickel tungsten sulfide. Preferably, the dehydrogenation metal is selected from platinum or nickel tungsten sulfide. The concentration of dehydrogenation metal on the hydroisomerization catalyst may comprise from 0.05 to 5 wt % based on the transition metal(s).

The dehydrogenation metal is distributed between the molecular sieve and the binder with about 40 to about 65 wt %, preferably 45 to about 60 wt %, of the metals distributed on the molecular sieve and about 40 to about 65 wt %, preferably 45 to about 60 wt %, of the metals distributed on the binder. The associated benefit of the hydroisomerization catalyst is high activity and selectivity toward hydroisomerization. In a further embodiment the hydroisomerization catalyst further comprises less than about 0.5 wt % carbon with the associated benefit of high activity and selectivity towards hydroisomerization.

In an embodiment, the hydroisomerization catalyst comprises one or more molecular sieves having a topology selected from AEI, AEL, AFO, AFX, ATO, BEA, CHA, FAU, FER, MEL, MFI, MOR, MRE, MTT, MWW or TON, such as EU-2, ZSM-11, ZSM-22, ZSM-23, ZSM-48, SAPO-5, SAPO-11, SAPO-31, SAPO-34, SAPO-41, SSZ-13, SSZ-16, SSZ-39, MCM-22, zeolite Y, ferrierite, mordenite, ZSM-5 or zeolite beta, with the associated benefit of the molecular sieve being active in the hydroisomerization of linear hydrocarbons.

The metal oxide binder may be taken from the group comprising alumina, silica, silica-alumina and titania or mixtures thereof. Preferably the metal oxide binder is alumina and preferably it is gamma alumina.

The hydroisomerization catalyst may comprise a molecular sieve having an AEL topology and more specifically it may be SAPO-11 Most of the acid sites on SAPO-11 are weak to moderate acid sites. More specifically, at least 50% of the total acidity on the SAPO-11 is weak acidity and at least 60-80% of the external acidity on SAPO-11 is weak acidity.

The hydroisomerization catalyst typically comprises particles having a diameter of about 1 to about 5 millimeters. The catalyst production typically involves the formation of a stable, porous support, followed by impregnation of active metals. The stable, porous support typically comprises a metal oxide as well as a molecular sieve, which may be a zeolite. The stable support is produced with a high porosity, to ensure maximum surface area, and it is typically desired to disperse the active metal over the full internal and external surface area of the support. DI-200 available from UOP LLC in Des Plaines, Illinois may be a suitable hydroisomerization catalyst.

Hydroisomerization conditions generally include a temperature of about 150° C. (302° F.) to about 450° C. (842° F.) and a pressure of about 1724 kPa (abs) (250 psia) to about 13.8 MPa (abs) (2000 psia). In another embodiment, the hydroisomerization conditions include a temperature of about 300° C. (572° F.) to about 388° C. (730° F.), a pressure of about 3102 kPa (abs) (450 psia) to about 13790 kPa (abs) (2000 psia), a LHSV of about 0.5 to 3 hr⁻¹ and a hydrogen rate of about 337 Nm³/m³ (2,000 scf/bbl) to about 2,527 Nm³/m³ oil (15,000 scf/bbl).

A hydroisomerized stream in a hydroisomerized line 50 from the hydroisomerization reactor 48 is a branched-paraffin-rich stream. Preferably the hydroisomerized stream is predominantly a branched paraffin stream. It is envisioned that the hydroisomerized effluent may contain 80, 90 or 95 mass-% branched paraffins of the total paraffin content. Hydroisomerization conditions in the hydroisomerization reactor 48 are selected to avoid undesirable cracking, so the predominant product in the hydroisomerized stream in the hydroisomerized line 50 is a branched paraffin. By avoiding undesirable cracking, the hydroisomerized stream in the hydroisomerized line 50 will have near and only slightly less of the same composition with regard to carbon numbers as the hydroisomerization feed stream in the hydroisomerization charge line 42. The optimal amount of remaining normal paraffins in line 50 is dependent on the selectivity of the hydroisomerization catalysts but might typically be between 1-7 wt-%.

The hydroisomerized stream in the hydroisomerized line 50 from the hydroisomerization reactor 48 flows to an hydroisomerate exchanger 52 to be heat exchanged with a stripper liquid hydroisomerized stream in the cold bottoms line 70 to cool it before it is mixed with the vaporous hydrocracked stream in line 182 to provide a mixed hydroisomerized stream in line 54. The mixed hydroisomerized stream in line 54 is further cooled in a hydroisomerization cooler 55 and fed to the hydroisomerization separator 56 for separation into a liquid hydroisomerized stream and vapor hydroisomerized stream. An internal packing may be located in the top of the hydroisomerization separator 56 to ensure liquid components are inhibited from leaving in a hydroisomerized overhead line 58. The vapor hydroisomerized stream in the hydroisomerized overhead line 58 extending from an overhead of hydroisomerization separator 56 may be compressed in the compressor 59 to provide the stripping gas in the stripping line 39 for the hydrotreating separator 36.

The liquid hydroisomerized stream in the hydroisomerization bottoms line 60 extending from a bottom of the hydroisomerization separator 56 may be fed to a stripping column 100 or to the product fractionation column 120 isolated from a hydrocracked liquid stream to be described hereinafter. In an embodiment, the liquid hydroisomerized stream in the hydroisomerization bottoms line 60 may be pumped to a cold separator 62 be further separated along with a cooled vaporous hydrotreated stream in line 38 and cold aqueous stream in the cold aqueous line 63 pumped around from the boot of the cold separator 62. The cold aqueous stream in line 63 may be combined with the vaporous hydrotreated stream in line 38 to provide a cooler hydrotreated stream in line 61. The cooler hydrotreated stream in line 61 may be cooled in a cooler 64 and combined with the liquid hydroisomerized stream in line 60 to provide a cold separator feed stream in line 66 and fed to the cold separator 62. The cold aqueous stream in the cold aqueous line 63 is added to the cold separator feed line 66 via the liquid hydroisomerized stream in line 60 to dissolve salts that may be present in the liquid hydrocarbon in the cold separator 62.

In the cold separator 62, vaporous components in the hydroisomerized liquid stream and the hydrotreated vapor stream will separate and ascend to provide a cold vapor hydroisomerized stream in a cold overhead line 68 and a stripper liquid hydroisomerized stream in a cold bottoms line 70 and a cold aqueous stream taken in a cold aqueous line 63 from the boot. The cold vapor hydroisomerized steam in the cold overhead line 68 may be split between a recycle hydrogen stream in line 19 and a net cold vapor hydroisomerized stream in a net cold overhead line 72. The recycle hydrogen stream in line 19 is compressed in a recycle gas compressor and recycled to the hydrotreating reactor 28 in the manifold line 18 for interbed quench and the hydrotreating hydrogen line 20 to the hydrocarbon stream in the feed line 12.

The net cold vapor hydroisomerized stream in the net cold overhead line 72 may be passed through a trayed or packed purge scrubbing column 74 where it is scrubbed by means of a scrubbing liquid such as an aqueous solution fed by scrubbing liquid line 76 to absorb acid gases including hydrogen sulfide and carbon dioxide by extracting them into the aqueous solution. Preferred scrubbing liquids include Selexol™ available from UOP LLC in Des Plaines, Illinois and amines such as alkanolamines including diethanol amine (DEA), monoethanol amine (MEA), methyl diethanol amine (MDEA), diisopropanol amine (DIPA), and diglycol amine (DGA). Other scrubbing liquids can be used in place of or in addition to the preferred amines. The lean scrubbing liquid contacts the cold vapor stream and absorbs acid gas contaminants. The resultant “sweetened” cold vapor stream is taken out from an overhead outlet of the purge scrubbing column 74 in a purge scrubber overhead line 78, and an acid gas rich scrubbing liquid is taken out from the bottoms at a bottom outlet of the purge scrubber column 74 in a purge scrubber bottoms line 80. The spent scrubbing liquid from the bottoms may be regenerated and recycled back to the purge scrubbing column 74 in the scrubbing liquid line 76. The scrubbed hydrogen-rich stream emerges from the purge scrubbing column 74 in the purge scrubber overhead line 78 and may be forwarded to a pressure-swing adsorption unit 82 or other hydrogen recovery plant to produce high purity hydrogen in line 84.

The purge scrubbing column 74 may be operated with a gas inlet temperature between about 38° C. (100° F.) and about 66° C. (150° F.) and an overhead pressure of about 3 MPa (gauge) (435 psig) to about 20 MPa (gauge) (2900 psig). Suitably, the purge scrubbing column 74 may be operated at a temperature of about 40° C. (104° F.) to about 125° C. (257° F.) and a pressure of about 1200 to about 1600 kPa. The temperature of the net cold vapor hydroisomerized stream 72 to the purge scrubbing column 74 may be between about 20° C. (68° F.) and about 80° C. (176° F.) and the temperature of the scrubbing liquid stream in the scrubbing liquid line 76 may be between about 20° C. (68° F.) and about 70° C. (158° F.).

Liquid hydroisomerized fuel components in the stripper liquid hydroisomerized stream from the liquid hydroisomerized stream and the vapor hydrotreated stream will exit the cold separator in the cold hydroisomerized bottoms line 70. The stripper liquid hydroisomerized stream in cold hydroisomerized bottoms line 70 comprises diesel and jet boiling range fuels as well as other hydrocarbons such as propane and naphtha. The cold aqueous stream may be collected from a boot of the cold separator in the cold aqueous line 63.

In an embodiment, the stripper liquid hydroisomerized stream in the cold bottoms line 70 may be stripped in a cold stripping column 86 to remove hydrogen sulfide and other gases. The stripper liquid hydroisomerized stream in the cold bottoms line 70 may be heated by heat exchange in the hydroisomerate exchanger 52 with a hydroisomerized stream in the hydroisomerized line 50 to heat the cold liquid hydroisomerized stream and fed to the cold stripping column 86.

In an embodiment the cold stripping column 86 may be part of a dual-stripping vessel 100 that comprises a cold stripping column 86 and a hot stripping column 102 which are isolated from each other by an intervening wall 103. A stripping media which is an inert gas such as steam from a stripping media line 89 may be used to strip light gases from the stripper liquid hydroisomerized stream in line 70. The cold stripping column 86 provides an overhead stripping stream of naphtha, LPG, hydrogen, hydrogen sulfide, steam and other gases in a stripper overhead line 87 and a fractionator hydroisomerized stream in a cold stripped bottoms line 90. The overhead stripping stream in the overhead line 87 may be condensed by cooling and separated in a stripping receiver 95. A stripper overhead line 88 from the receiver 95 may carry a stripper overhead stream to an off-gas scrubber 140. Unstabilized liquid naphtha from the bottoms of the receiver 95 may be split to provide a reflux stream to the cold stripping column 86 and a stripper liquid overhead stream that may be transported in a stripper receiver bottoms line 96 to a debutanizer column 170 for naphtha and LPG recovery. A sour water stream may be collected from a boot of the overhead receiver 95.

The cold stripping column 86 may be operated with an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 95 ranges from about 38° C. (100° F.) to about 66° C. (150° F.) and the pressure is essentially the same as in the overhead of the cold stripping column 86. It is envisioned that the cold stripping column 86 and the hot stripping column 102 may be two completely separate vessels.

The fractionator liquid hydroisomerized stream in the cold stripper bottoms line 90 may be heated and fed to the product fractionation column 120. A fractionator liquid hydrocracked stream in a hot stripper bottoms line 106 may also be heated and fed to the product fractionation column 120. The fractionator liquid hydrocracked stream in the hot stripper bottoms line 106 is a separate liquid stream from the fractionator liquid hydroisomerized stream in the cold stripper bottoms line 90 which is also a liquid stream. The fractionator liquid hydrocracked stream in the hot stripper bottoms line 106 may be fed to the product fractionation column 120 separately from said fractionator liquid hydroisomerized stream in the cold stripper bottoms line 90 or together. However, the fractionator liquid hydrocracked stream in the hot stripper bottoms line 106 and the fractionator liquid hydroisomerized stream in the cold stripper bottoms line 90 are generated separately. Taking and keeping these streams separate until stripping or fractionation serves to preserve heat in the fractionator liquid hydrocracked stream to require less heat to boil the kerosene range boiling components to separate them from the diesel components in the product fractionation column 120.

A diesel stream in a bottoms line 124 is taken from a bottom of the product fractionation column 120. A hydrocracking charge stream in line 126 is taken from the diesel stream in the bottoms line 124 from the product fractionation column 120. The product fractionation column 120 may be reboiled by heat exchange with a suitable hot stream or in a fired heater 121 to provide the necessary heat for the distillation. Alternately, a stripping media which is an inert gas such as steam from a stripping media line may be used to heat the column. A reboil stream is taken to the fired heater 121 and returned boiling to the product fractionation column 120. A diesel product stream may be taken in a diesel product line 125 to a diesel pool and may be green diesel. The diesel stream in the distillation bottoms line 124 may be a diesel stream having a T5 of about 230° C. (446° F.) to about 296° C. (590° F.) and a T90 of about 343° C. (650° F.) to about 399° C. (750° F.).

The product fractionation column 120 provides an overhead gaseous stream of naphtha in an overhead line 122. The fractionation overhead stream may be completely condensed and separated from water in a fractionation receiver 130. Unstabilized liquid naphtha from the bottom of the receiver 130 in a fractionator overhead liquid line 132 may combined with a naphtha stream in line 176 while a condensed reflux stream is refluxed to the column. A sour water stream may be collected from a boot of the distillation receiver 130.

A kerosene stream may be taken from the side of the product fractionation column 120 in a side line 134. The kerosene stream taken in the side line 134 may be stripped in a kerosene stripper column 136 to drive off lower boiling materials which are returned back to the product fractionation column 120 at a higher elevation in an overhead kerosene line 135. A stripped bottoms kerosene stream is produced in a bottoms kerosene line 137, from which a boil up stream is reboiled and fed back to the kerosene stripper column 136 and a jet fuel product stream is taken in line 138. The jet fuel product stream in line 138 meets jet fuel specifications per ASTM D86 and may be a green jet fuel stream taken from a bottom of the kerosene stripper column 136. The jet fuel product stream in line 138 may be cooled and transported to the jet fuel pool.

Optionally a light diesel stream may be taken in a second side line and stripped in a side diesel stripper that are not shown. Additionally, heat may be removed from the product fractionation column in a pump-around steam generator 139.

The product fractionation column 120 may be operated with a bottoms temperature between about 149° C. (300° F.) and about 288° C. (550° F.), preferably no more than about 260° C. (500° F.), and an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 130 ranges from about 38° C. (100° F.) to about 66° C. (150° F.) and the pressure is essentially the same as in the overhead of the product fractionation column 120. It is also envisioned that the product fractionation column 120 may just provide a net overhead stream comprising jet fuel in the fractionator overhead liquid line 132, with naphtha and lighter stream taken in the fractionator receiver overhead line 131. In such a case, compressor 133 would not be required.

The overhead stripping stream of naphtha, LPG, hydrogen, hydrogen sulfide, steam and other gases in the stripper overhead line 88 may be passed through a trayed or packed off-gas scrubbing column 140 where it is scrubbed by means of a scrubbing liquid such as an aqueous solution fed by scrubbing liquid line 142 to remove acid gases including hydrogen sulfide and carbon dioxide by extracting them into the aqueous solution. Preferred scrubbing liquids include Selexol™ available from UOP LLC in Des Plaines, Illinois and amines such as alkanolamines including diethanol amine (DEA), monoethanol amine (MEA), methyl diethanol amine (MDEA), diisopropanol amine (DIPA), and diglycol amine (DGA). Other scrubbing liquids can be used in place of or in addition to the preferred amines. The lean scrubbing liquid contacts the overhead stripping stream and absorbs acid gas contaminants such as hydrogen sulfide and carbon dioxide. The resultant “sweetened” overhead stripping stream is taken out from an overhead outlet of the off-gas scrubbing column 140 in a recycle scrubber overhead line 144, and an acid gas rich scrubbing liquid is taken out from the bottoms at a bottom outlet of the recycle scrubber column 140 in a recycle scrubber bottoms line 146. The spent scrubbing liquid from the bottoms may be regenerated and recycled back to the off-gas scrubbing column 140 in the scrubbing liquid line 142. The scrubbed hydrocarbon-rich stream emerges from the off-gas scrubbing column 140 via the off-gas scrubber overhead line 144 and may be forwarded to the sponge absorber column 160 for hydrocarbon recovery.

The off-gas scrubbing column 140 may be operated with a gas inlet temperature between about 38° C. (100° F.) and about 66° C. (150° F.) and an overhead pressure of about 3 MPa (gauge) (435 psig) to about 20 MPa (gauge) (2900 psig). Suitably, the off-gas scrubbing column 140 may be operated at a temperature of about 40° C. (104° F.) to about 125° C. (257° F.) and a pressure of about 1200 to about 1600 kPa. The temperature of the overhead stripping stream 88 to the off-gas scrubbing column 140 may be between about 20° C. (68° F.) and about 80° C. (176° F.) and the temperature of the scrubbing liquid stream in the scrubbing liquid line 142 may be between about 20° C. (68° F.) and about 70° C. (158° F.).

The sponge absorber column 160 may receive the scrubbed hydrocarbon-rich stream in the off-gas scrubber overhead line 144. A lean absorbent stream in a lean absorbent line 162 may be fed into the sponge absorber column 160 through an absorbent inlet. The lean absorbent may comprise a naphtha stream in a lean absorbent line 162 perhaps from the debutanizer bottoms stream in line 176. In the sponge absorber column 160, the lean absorbent stream and the scrubbed hydrocarbon-rich stream are counter-currently contacted. The sponge absorbent absorbs LPG hydrocarbons from the net stripper gaseous stream into an absorbent rich stream.

The hydrocarbons absorbed by the sponge absorbent include some methane and ethane and most of the LPG, C₃ and C₄. hydrocarbons, and any C₅ and C₆₊ light naphtha hydrocarbons in the net stripper gaseous stream. The sponge absorber column 160 operates at a temperature of about 34° C. (93° F.) to about 60° C. (140° F.) and a pressure essentially the same as or lower than the off-gas scrubbing column 140 less frictional losses. A sponge absorption off gas stream depleted of LPG hydrocarbons is withdrawn from a top of the sponge absorber column 160 at an overhead outlet through a sponge absorber overhead line 164. The sponge absorption off gas stream in the sponge absorber overhead line 164 may be transported to a fuel gas header that is not shown for providing fuel gas needs. A rich absorbent stream rich in LPG hydrocarbons is withdrawn in a rich absorber bottoms line 166 from a bottom of the sponge absorber column 160 at a bottoms outlet which may be fed to a debutanizer column 170 via the stripper overhead liquid stream in the stripper receiver bottoms line 96.

In an embodiment, the debutanizer column 170 may fractionate the stripper liquid overhead stream and the rich absorbent stream in the stripper receiver bottoms line 134 into a debutanized bottoms stream comprising predominantly C₅₊ hydrocarbons and a debutanizer overhead stream comprising LPG hydrocarbons. The debutanizer overhead stream in a debutanizer overhead line 172 may be fully condensed with reflux to the debutanizer column 170 and recovery of LPG in a debutanized overhead liquid stream in a debutanizer net receiver bottoms line 174. The debutanized overhead liquid stream in the net receiver bottoms line 174 may be taken as a LPG product stream. The debutanized bottoms stream may be withdrawn from a bottom of the debutanizer column 170 in a debutanized bottoms line 176. A reboil stream taken from a debutanized bottoms stream in a debutanizer bottoms line 175 from a bottom of the debutanizer column 170 may be boiled up in the reboil line and sent back to the debutanizer column 170 to provide heat to the column. Alternatively, a hot inert media stream such as steam may be fed to the column 170 to provide heat. A net debutanized bottoms stream in line 176 comprising naphtha may be split between the lean absorbent stream in the lean absorbent line 162 and a product naphtha stream which is cooled and forwarded to a gasoline pool in line 178.

The fractionation bottoms stream in the fractionation bottoms line 124 may comprise diesel boiling range hydrocarbons. In the embodiment of FIG. 1 the jet fuel stream in the line 138 and the diesel stream in line 125 may be taken once through, with no recycle. The cut point in the product fractionation column 120 between the diesel stream in the bottoms line 124 and the jet fuel stream in the side line 134 can be adjusted to ensure that the jet fuel stream has the appropriate composition to meet jet fuel specifications, at least after blending, particularly to meet the jet fuel density specification. However, because the larger paraffins are concentrated in the fractionation bottoms stream it is well suited for hydrocracking to kerosene range hydrocarbons.

The hydrocracking charge stream in the hydrocracking charge line 126 may be reserved in a hydrocracking charge surge drum 127 and pumped to the hydrocracking reactor 150. The hydrocracking reactor 150 is downstream of the hydroisomerization reactor 48. The hydrocracking charge stream may be mixed with a hydrocracking hydrogen stream in line 152 taken from the compressed make-up hydrogen stream in compressed make-up gas header 47 to provide combined hydrocracking charge stream in a combined hydrocracking charge line 154, heated by heat exchanged with a hydrocracked stream in line 158 in a hydrocracking effluent charge heater 155 and charged in line 154 to the hydrocracking reactor 150.

The hydrocracking reactor 150 may be a fixed bed reactor that comprises one or more vessels, single or multiple catalyst beds in each vessel, and various combinations of hydrocracking catalyst in one or more vessels. The hydrocracking reactor 150 may be operated in a conventional continuous gas phase, a moving bed or a fluidized bed hydroprocessing reactor.

The combined hydrocracking stream is hydrocracked over a hydrocracking catalyst in the hydrocracking reactor 150 in the presence of a hydrocracking hydrogen stream from a hydrocracking hydrogen line 152 to provide a hydrocracked stream. A portion of the hydrocracking charge stream in line 126 may be used as an interbed quench to cool hydrocracked effluent between catalyst beds. In an alternative aspect, the recycle hydrogen from the recycle hydrogen line 19 may be added between hydrocracking catalyst beds.

The hydrocracking reactor may provide a total conversion of at least about 20 vol % and typically greater than about 60 vol % of the hydrocracking charge stream in the hydrocracking charge line 126 to products boiling below the heavy diesel range of about 293° C. (560° F.) to about 310° C. (590° F.). The hydrocracking reactor 150 may operate at partial conversion of more than about 30 vol % or full conversion of at least about 90 vol % of the feed based on total conversion. The hydrocracking reactor 150 may be operated at mild hydrocracking conditions which will provide about 20 to about 60 vol %, preferably about 20 to about 50 vol %, total conversion of the hydrocracking charge stream to product boiling below the heavy diesel boiling range.

The hydrocracking catalyst may utilize amorphous silica-alumina bases or zeolite bases combined with one or more Group VIII or Group VIB metal hydrogenating components to selectively produce a balance of light diesel and jet fuel distillate. In another aspect, a catalyst which comprises, in general, any crystalline zeolite cracking base upon which is deposited a Group VIII metal hydrogenating component may be suitable. Additional hydrogenating components may be selected from Group VIB for incorporation with the zeolite base. Moreover, the hydroisomerization catalyst from the hydroisomerization reactor 48 can be used as hydrocracking catalyst in the hydrocracking reactor 150 but run at the high end of the hydroisomerization temperature range.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms. It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms, wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,100,006.

Mixed polyvalent metal-hydrogen zeolites may be prepared by ion-exchanging with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 wt %, and preferably at least about 20 wt %, metal-cation-deficient, based on the initial ion-exchange capacity. In another aspect, a desirable and stable class of zeolites is one wherein at least about 20 wt % of the ion exchange capacity is satisfied by hydrogen ions.

The active metals employed in the preferred hydrocracking catalysts of the present disclosure as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 wt % and about 30 wt % may be used. In the case of the noble metals, it is normally preferred to use about 0.05 to about 2 wt % noble metal. Noble metals may be preferred as the hydrogenation metal on the hydrocracking catalyst to provide selectivity to jet fuel due to the absence of hydrogen sulfide and ammonia which can deactivate noble metal catalysts, but which have been removed upstream in the process.

The method for incorporating the hydrogenation metal is to contact the base material with an aqueous solution of a suitable compound of the desired metal wherein the metal is present in a cationic form. Following addition of the selected hydrogenation metal or metals, the resulting catalyst powder is then filtered, dried, pelleted with added lubricants, binders or the like if desired, and calcined in air at temperatures of, e.g., about 371° C. (700° F.) to about 648° C. (200° F.) in order to activate the catalyst and decompose ammonium ions. Alternatively, the base component may be pelleted, followed by the addition of the hydrogenation component and activation by calcining.

The foregoing catalysts may be employed in undiluted form, or the powdered catalyst may be mixed and completed with other relatively less active catalysts, diluents or binders such as alumina, silica gel, silica-alumina cogels, activated clays and the like in proportions ranging between about 5 and about 90 wt %. These diluents may be employed as such, or they may contain a minor proportion of an added hydrogenating metal such as a Group VIB and/or Group VIII metal. Additional metal promoted hydrocracking catalysts may also be utilized in the process of the present disclosure which comprises, for example, aluminophosphate molecular sieves, crystalline chromosilicates and other crystalline silicates. Crystalline chromosilicates are more fully described in U.S. Pat. No. 4,363,178.

By one approach, the hydrocracking conditions may include a temperature from about 290° C. (550° F.) to about 468° C. (875° F.), preferably 300° C. (572° F.) to about 445° C. (833° F.), a pressure from about 2.7 MPa (gauge) (400 psig) to about 20.7 MPa (gauge) (3000 psig), a liquid hourly space velocity (LHSV) from about 0.4 to less than about 2.5 hr⁻¹ and a hydrogen rate of about 337 Nm³/m³ (2,000 scf/bbl) to about 2,527 Nm³/m³ oil (15,000 scf/bbl).

The hydrocracked stream may exit the hydrocracking reactor 150 in a hydrocracked line 158. In an embodiment, the hydrocracked stream may be cooled by heat exchange with the combined hydrocracking charge stream in line 154 and transported to a hydrocracking separator 180 to be separated. The hydrocracked stream may be separated in a hydrocracking separator 180 to provide a vapor hydrocracked stream in a hydrocracking separator overhead line 182 and a liquid hydrocracked stream comprising a stripper liquid hydrocracked stream in a hydrocracking separator bottoms line 184. The hydrocracking separator 180 may be in downstream communication with the hydrocracking reactor 150.

The hydrocracking separator 180 operates at about 177° C. (350° F.) to about 371° C. (700° F.) and preferably operates at about 232° C. (450° F.) to about 315° C. (600° F.). The hydrocracking separator 180 may be operated at a slightly lower pressure than the hydrocracking reactor 150 accounting for pressure drop through intervening equipment. The hydrocracking separator 180 may be operated at pressures between about 3.4 MPa (gauge) (493 psig) and about 20.4 MPa (gauge) (2959 psig). The vapor hydrocracked stream in the hydrocracking separator overhead line 182 may have a temperature of the operating temperature of the hydrocracking separator 180. The vaporous hydrocracked stream in the hydrocracking separator overhead line 182 may be combined with the cooled hydroisomerized stream 52 in the hydroisomerized line 50 to provide a mixed hydroisomerized stream in line 54 and separated together in the hydroisomerization separator 56. Only the vaporous components of the hydrocracked stream are mixed with the liquid components of the hydroisomerized stream to retain heat in the liquid hydrocracked stream in line 184. Hence, a liquid hydrocracked stream is not mixed with a liquid hydroisomerized stream but are still isolated from each other until stripping or fractionation.

The stripper liquid hydrocracked stream in line 184 may be fed to the hot stripping column 102 to be stripped of lighter gases. In an embodiment, the stripper liquid hydrocracked stream in line 184 may be stripped in the hot stripping column 102 to remove hydrogen sulfide, naphtha and lighter gases. The stripper liquid hydrocracked stream in the hydrocracked bottoms line 184 may be fed directly to the hot stripping column 102 without undergoing cooling. The hot stripping column 102 may be operated with a bottoms temperature between about 149° C. (300° F.) and about 288° C. (550° F.), preferably no more than about 260° C. (500° F.).

In an embodiment, the hot stripping column 102 may be part of a dual-stripping vessel 100 that comprises the cold stripping column 86 and the hot stripping column 102 which are isolated from each other by an intervening wall 103. A stripping media which is an inert gas such as steam from a hot stripping media line 104 may be used to strip light gases from the stripper liquid hydrocracked stream in line 184. The hot stripping column 86 provides an overhead stripping stream of naphtha, LPG, hydrogen, hydrogen sulfide, steam and other gases in a hot stripper overhead line 105 and a fractionator liquid hydrocracked stream in a hot stripped bottoms line 106. The hot stripper overhead line 105 is preferably fed to the cold stripping column 86 to be further stripped of lighter boiling components. The fractionator liquid hydrocracked stream in the hot stripped line 106 is heated preferably without a fired heater and fed to the product fractionation column 120 at a feed location that is above the feed location for the fractionator liquid hydroisomerized stream in cold stripped bottoms line 90. The fractionator liquid hydrocracked stream is fractionated in the product fractionation column 120 with the fractionator liquid hydroisomerized stream as described previously.

It is important that the liquid fuel components in the hydrocracked stream 158, particularly the kerosene components, be isolated from the liquid fuel components in the hydroisomerized stream in line 50 to preserve heat in the hydrocracked stream, so as to avoid having to heat the fuel components in the hydrocracked stream back up to kerosene boiling temperature to separate the kerosene components from the diesel components. In an aspect, the hydroisomerized stream in line 50 and the hydrocracked stream in line 158 are completely isolated from each other before they are separated in their respective separators 56 and 180, respectively. The liquid hydrocracked stream from the hydrocracking separator 180 in line 184 is isolated from the liquid hydroisomerized stream in line 60 from the hydroisomerization separator 56 and the stripper liquid hydroisomerized stream in line 70 from the cold separator 62. Moreover, the fractionator liquid hydroisomerized stream in line 90 is isolated from the fractionator liquid hydrocracked stream in line 106.

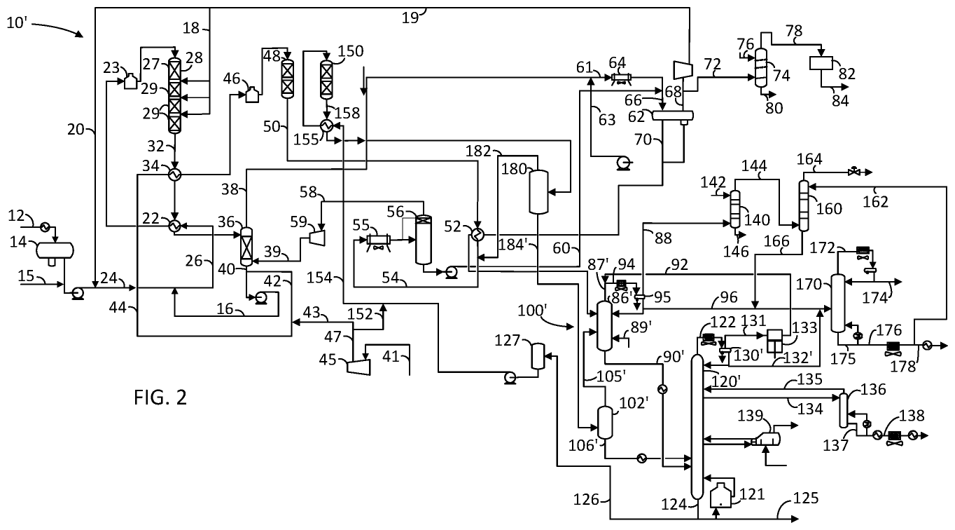

FIG. 2 is a further alternative embodiment to FIG. 1 of a process 10′ which flashes a liquid hydrocracked stream taken from said hydrocracked stream to provide a fractionator liquid hydrocracked stream separately from stripping said stripper hydroisomerized stream. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The configuration and operation of the embodiment of FIG. 2 is essentially the same as in FIG. 1 with the following exceptions.

The stripping vessel 100′ of FIG. 2 is a single stripping column 86′ which receives and strips light gases from the stripper liquid hydroisomerized stream in the cold bottoms line 70 with an inert gas such as steam from a stripping media line 89′. The product fractionation column 120′ provides an overhead gaseous stream of naphtha in an overhead line 122. The fractionation overhead stream may be condensed and separated from water in a fractionation receiver 130′. Unstabilized liquid naphtha from the bottom of the receiver 130′ in a fractionator overhead liquid line 132′ may be fed to the debutanizer column 170 perhaps with the stripper liquid overhead stream in the stripper receiver bottoms line 96 and the rich absorbent stream in the rich absorber bottoms line 166 while a condensed reflux stream is refluxed to the column. A fractionator off-gas stream in line 131 may be compressed in an off-gas compressor 133 to provide a compressed off-gas stream in line 92 and combined with the cold stripper overhead stream in the cold stripper overhead line 87′ to provide the condenser stream in line 94. The overhead stripping stream in the overhead line 87′ may be combined with an off-gas compression stream in line 92 to make a condenser stream in line 94. The condenser stream in line 94 is condensed by cooling and separated in a stripping receiver 95. The fractionator liquid hydroisomerized stream in a stripped bottoms line 90′ is fed to the product fractionation column 120′ for fractionation.

The liquid hydrocracked stream in the hydrocracked bottoms line 184′ is fed to a hydrocracking flash drum 102′ to provide a flash vaporous hydrocracked stream in a flash overhead line 105′ and a fractionator liquid hydrocracked stream in the flash bottoms line 106′. The vaporous flash hydrocracked stream in the flash overhead line 105′ may be fed to the stripping column 86′ to be stripped of volatiles with the stripping liquid hydroisomerized stream from the cold bottoms line 70. The fractionator liquid hydrocracked stream in the flash bottoms line 106′ may be fed to the product fractionation column 120 at a location above the feed for the fractionator liquid hydroisomerized stream in line 90′.

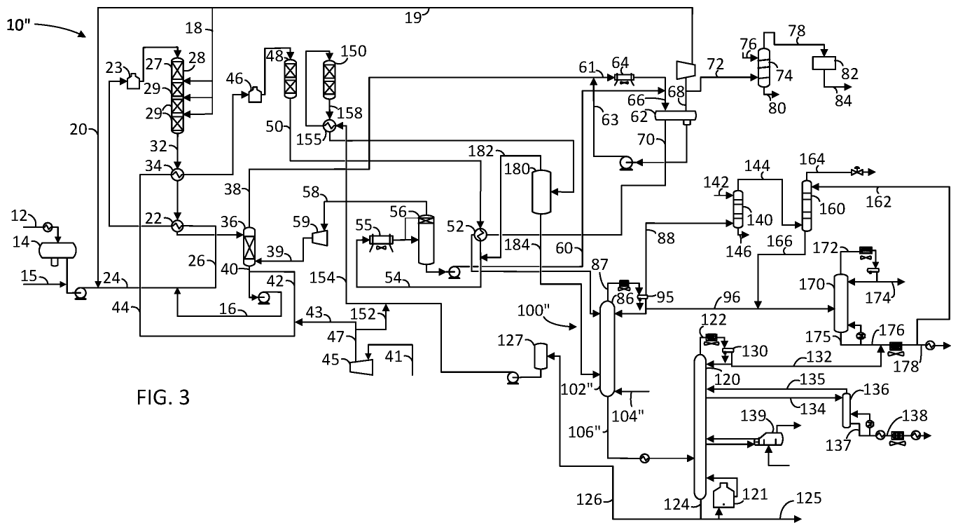

FIG. 3 is a further alternative embodiment to FIG. 1 of the process 10″ which strips the cold stripper liquid hydroisomerized stream in line 70 and the stripper liquid hydrocracked stream in line 184 in the same stripping column 102″ in a single stripping vessel 100′. Elements in FIG. 3 with the same configuration as in FIG. 1 will have the same reference numeral as in FIG. 1. Elements in FIG. 3 which have a different configuration as the corresponding element in FIG. 1 will have the same reference numeral but designated with a double prime symbol (″). The configuration and operation of the embodiment of FIG. 3 is essentially the same as in FIG. 1 with the following exceptions. A single stripped fractionation liquid stream comprising the stripped liquid hydroisomerized stream and the stripped liquid hydrocracked stream in the stripped line 106″ is fed to the product fractionation column 120. The fractionator overhead gaseous stream 122 is fully condensed, so the fractionator receiver 130 only produces a liquid bottoms stream of which a part is refluxed and the remaining liquid naphtha in the overhead liquid line 132 is fed to be combined with the naphtha stream in the debutanized naphtha stream in line 176 to produce the product naphtha stream in line 178.

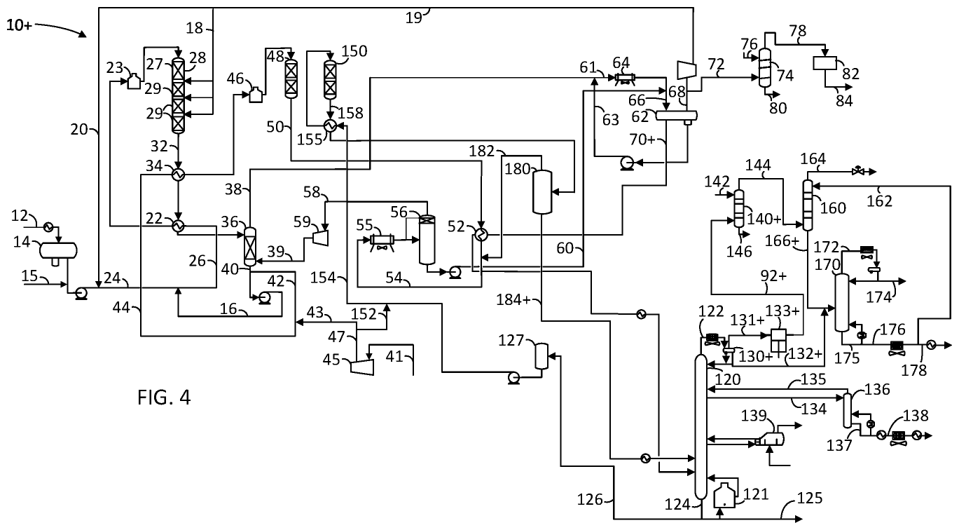

FIG. 4 is a further alternative embodiment to FIG. 1 of the process 10+ in which the cold liquid hydroisomerized stream in line 70+ and the liquid hydrocracked stream in line 184+ are not stripped but fed directly to the product fractionation column 120. Elements in FIG. 4 with the same configuration as in FIG. 1 will have the same reference numeral as in FIG. 1. Elements in FIG. 4 which have a different configuration as the corresponding element in FIG. 1 will have the same reference numeral but designated with a cross symbol (+). The configuration and operation of the embodiment of FIG. 4 is essentially the same as in FIG. 1 with these foregoing and following exceptions.

The stripping column 100 of FIG. 1 and all accessories thereto are absent from FIG. 4. The fractionator off-gas stream in the fractionator receiver overhead line 131+ is compressed in an off-gas compressor 133+ to provide an off-gas compression stream in line 92+ and fed to the off-gas scrubbing column 140+. Moreover, a rich absorber bottoms stream in the rich absorber bottoms line 166+ from a bottom of the sponge absorber column 160 may be fed to a debutanizer column 170. Unstabilized liquid naphtha from the bottom of the receiver 130+ in a fractionator overhead liquid line 132+ may be fed to the debutanizer column 170 perhaps the rich absorbent stream in the rich absorber bottoms line 166+ while a condensed reflux stream is refluxed to the column.

All of the liquid hydrocracked streams in lines 184 or 106 may be isolated from any of the liquid hydroisomerized streams in lines 60, 70 and 90 in FIG. 1 before entering the stripping column 100 or the product fractionation column 120. This arrangement prevents kerosene in the liquid hydrocracked streams from being cooled and reboiled in the product fractionation column 120 which wastes heat. It is envisioned that the liquid hydrocracked stream and the liquid hydroisomerized stream could enter the product fractionation column together.

### Example

We simulated the disclosed process which employs dedicated separators for the hydroisomerized effluent and for the hydrocracked effluent. The duty for each heater or exchanger is provided in the Table below. In the Table, reference numerals for the elements in the drawings are provided for each heater or exchanger, except for one not shown in the Figure.

| | TABLE | |
|---|---|---|
| | Duty, MMBtu/hr | |
| | Base | Disclosed |
| Exchangers | Case | Fractionation Process |
| Treating Combined Feed Exchanger | 72.39 | 76.3 |
| (22) | | |
| Treating Combined Feed Heater (23) | 14.87 | 11 |
| Combined Isomerization Feed Exchanger | 27 | 29 |
| (34) | | |
| Hydroisomerization Charge Heater (46) | 7 | 5 |
| Treating Effluent-Cracking Feed | 17 | 17 |
| Exchanger | | |
| Hydrocracking Effluent Charge Heater | 19.88 | 19.88 |
| (155) | | |
| Hydroisomerate Exchanger (52) | 41.2 | 20 |
| Fractionator Reboiler Duty (121) | 69 | 42 |

It is evident that the disclosed process substantially reduces duty in the Fractionator Reboiler 121 and in the Hydroisomerate Exchanger 52.

### Specific Embodiments

While the following is described in conjunction with specific embodiments, it will be understood that this description is intended to illustrate and not limit the scope of the preceding description and the appended claims.

A first embodiment of the process for hydroprocessing hydrocarbon streams comprises hydroisomerizing a hydroisomerization charge stream in the presence of hydrogen over a hydroisomerization catalyst to provide a hydroisomerized stream; hydrocracking a hydrocracking charge stream in the presence of hydrogen to provide a hydrocracked stream; separating a liquid hydroisomerized stream from the hydroisomerized stream; separating a liquid hydrocracked stream from the hydrocracked stream that is separate from the liquid hydroisomerized stream; and feeding the liquid hydroisomerized stream to a product fractionation column; and feeding the liquid hydrocracked stream to the product fractionation column. An embodiment of the disclosure is one, any or all of prior embodiments in this paragraph up through the first embodiment in this paragraph further comprising separating the hydrocracked stream in a hydrocracking separator to provide a vaporous hydrocracked stream and a liquid hydrocracked stream and feeding the liquid hydrocracked stream to the fractionation column. An embodiment of the disclosure is one, any or all of prior embodiments in this paragraph up through the first embodiment in this paragraph further comprising separating the hydroisomerized stream in a hydroisomerization separator to provide a vaporous hydroisomerized stream and the liquid hydroisomerized stream and feeding the liquid stream to the fractionation column. An embodiment of the disclosure is one, any or all of prior embodiments in this paragraph up through the first embodiment in this paragraph wherein the hydroisomerization charge stream is a biorenewable stream. An embodiment of the disclosure is one, any or all of prior embodiments in this paragraph up through the first embodiment in this paragraph wherein the hydrocracking charge stream is taken from the product fractionation column. An embodiment of the disclosure is one, any or all of prior embodiments in this paragraph up through the first embodiment in this paragraph further comprising cooling the liquid hydroisomerized stream and separating the cooled liquid hydroisomerized stream into a cold vapor hydroisomerized stream and a cold liquid hydroisomerized stream and feeding the cold liquid hydroisomerized stream to the fractionation column. An embodiment of the disclosure is one, any or all of prior embodiments in this paragraph up through the first embodiment in this paragraph further comprising mixing the vaporous hydrocracked stream with the liquid hydroisomerized stream. An embodiment of the disclosure is one, any or all of prior embodiments in this paragraph up through the first embodiment in this paragraph further comprising stripping a hydroisomerized stream to provide the liquid hydroisomerized stream and stripping a hydrocracked stream to provide the liquid hydrocracked stream separately from stripping the hydroisomerized stream. An embodiment of the disclosure is one, any or all of prior embodiments in this paragraph up through the first embodiment in this paragraph further comprising stripping a hydroisomerized stream and flashing a hydrocracked stream to provide the liquid hydrocracked stream separately from stripping the hydroisomerized stream. An embodiment of the disclosure is one, any or all of prior embodiments in this paragraph up through the first embodiment in this paragraph further comprising hydrotreating a hydrocarbon stream to provide a hydrotreated stream and separating the hydrotreated stream to provide a vaporous hydrotreated stream and a liquid hydrotreated stream and taking the hydroisomerization charge stream from the liquid hydrotreated stream.

A second embodiment is a process for hydroprocessing hydrocarbon streams comprising hydroisomerizing a hydroisomerization charge stream in the presence of hydrogen over a hydroisomerization catalyst to provide a hydroisomerized stream; separating the hydroisomerized stream in a hydroisomerization separator to provide a vaporous hydroisomerized stream and a liquid hydroisomerized stream; taking a fractionator hydroisomerized stream from the liquid hydroisomerized stream; hydrocracking a hydrocracking charge stream in the presence of hydrogen to provide a hydrocracked stream; separating the hydrocracked stream in a hydrocracking separator to provide a vaporous hydrocracked stream and a liquid hydrocracked stream; taking a fractionator hydrocracked stream from the liquid hydrocracked stream; feeding the fractionator hydroisomerized stream to a product fractionation column; and feeding the fractionator hydrocracked stream to the product fractionation column. An embodiment of the disclosure is one, any or all of prior embodiments in this paragraph up through the second embodiment in this paragraph wherein the hydroisomerization charge stream is a biorenewable stream. An embodiment of the disclosure is one, any or all of prior embodiments in this paragraph up through the second embodiment in this paragraph further comprising cooling the liquid hydroisomerized stream to provide a cooled liquid hydroisomerized stream and separating a cooled liquid hydroisomerized stream into a cold vaporous hydroisomerized stream and a cold liquid hydroisomerized stream and taking the fractionator hydroisomerized stream from the cold liquid hydroisomerized stream. An embodiment of the disclosure is one, any or all of prior embodiments in this paragraph up through the second embodiment in this paragraph further comprising mixing the vaporous hydrocracked stream with the liquid hydroisomerized stream. An embodiment of the disclosure is one, any or all of prior embodiments in this paragraph up through the second embodiment in this paragraph further comprising stripping a stripper hydroisomerized stream taken from the cold liquid hydroisomerized stream to provide the fractionator hydroisomerized stream and stripping a stripper hydrocracked stream taken from the liquid hydrocracked stream to provide the fractionator hydrocracked stream. An embodiment of the disclosure is one, any or all of prior embodiments in this paragraph up through the second embodiment in this paragraph further comprising stripping a stripper hydroisomerized stream taken from the cold liquid hydroisomerized stream to provide the fractionator hydroisomerized stream and flashing the liquid hydrocracked stream to provide the fractionator hydrocracked stream. An embodiment of the disclosure is one, any or all of prior embodiments in this paragraph up through the second embodiment in this paragraph further comprising hydrotreating a hydrocarbon stream to provide a hydrotreated stream and separating the hydrotreated stream to provide a vaporous hydrotreated stream and a liquid hydrotreated stream and taking the hydroisomerization charge stream from the liquid hydrotreated stream.

A third embodiment of the process for hydroprocessing a biorenewable feed stream comprises hydroisomerizing a hydroisomerization charge stream in the presence of hydrogen over a hydroisomerization catalyst to provide a hydroisomerized stream; hydrocracking a hydrocracking charge stream in the presence of hydrogen to provide a hydrocracked stream; separating a liquid hydroisomerized stream from the hydroisomerized stream; separating a liquid hydrocracked stream from the hydrocracked stream that is separate from the liquid hydroisomerized stream; feeding the liquid hydroisomerized stream to a product fractionation column; and feeding the liquid hydrocracked stream to the product fractionation column. An embodiment of the disclosure is one, any or all of prior embodiments in this paragraph up through the third embodiment in this paragraph further comprising stripping a stripper hydroisomerized stream taken from the hydroisomerized stream to provide the liquid hydroisomerized stream and stripping a stripper hydrocracked stream taken from the hydrocracked stream to provide the liquid hydrocracked stream separately from stripping the stripper hydroisomerized stream. An embodiment of the disclosure is one, any or all of prior embodiments in this paragraph up through the third embodiment in this paragraph further comprising stripping a stripper hydroisomerized stream taken from the hydroisomerized stream to provide the liquid hydroisomerized stream and flashing a flash liquid stream taken from the hydrocracked stream to provide the liquid hydrocracked stream separately from stripping the stripper hydroisomerized stream.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for hydroprocessing hydrocarbon streams comprising:
hydroisomerizing a hydroisomerization charge stream in the presence of hydrogen over a hydroisomerization catalyst to provide a hydroisomerized stream;
hydrocracking a hydrocracking charge stream in the presence of hydrogen to provide a hydrocracked stream;
separating a liquid hydroisomerized stream from said hydroisomerized stream;
separating a liquid hydrocracked stream from said hydrocracked stream that is separate from said liquid hydroisomerized stream; and
feeding said liquid hydroisomerized stream to a product fractionation column; and feeding said liquid hydrocracked stream to said product fractionation column.

2. The process of claim 1 further comprising separating said hydrocracked stream in a hydrocracking separator to provide a vaporous hydrocracked stream and a liquid hydrocracked stream and feeding said liquid hydrocracked stream to said fractionation column.

3. The process of claim 2 further comprising separating said hydroisomerized stream in a hydroisomerization separator to provide a vaporous hydroisomerized stream and said liquid hydroisomerized stream and feeding said liquid stream to said fractionation column.

4. The process of claim 1 wherein said hydroisomerization charge stream is a biorenewable stream.

5. The process of claim 1 wherein said hydrocracking charge stream is taken from said product fractionation column.

6. The process of claim 3 further comprising cooling said liquid hydroisomerized stream and separating said cooled liquid hydroisomerized stream into a cold vapor hydroisomerized stream and a cold liquid hydroisomerized stream and feeding said cold liquid hydroisomerized stream to said fractionation column.

7. The process of claim 6 further comprising mixing said vaporous hydrocracked stream with said liquid hydroisomerized stream.

8. The process of claim 1 further comprising stripping a hydroisomerized stream to provide said liquid hydroisomerized stream and stripping a hydrocracked stream to provide said liquid hydrocracked stream separately from stripping said hydroisomerized stream.

9. The process of claim 1 further comprising stripping a hydroisomerized stream and flashing a hydrocracked stream to provide said liquid hydrocracked stream separately from stripping said hydroisomerized stream.

10. The process of claim 1 further comprising hydrotreating a hydrocarbon stream to provide a hydrotreated stream and separating said hydrotreated stream to provide a vaporous hydrotreated stream and a liquid hydrotreated stream and taking said hydroisomerization charge stream from said liquid hydrotreated stream.

11. A process for hydroprocessing hydrocarbon streams comprising:
hydroisomerizing a hydroisomerization charge stream in the presence of hydrogen over a hydroisomerization catalyst to provide a hydroisomerized stream;
separating said hydroisomerized stream in a hydroisomerization separator to provide a vaporous hydroisomerized stream and a liquid hydroisomerized stream;
taking a fractionator hydroisomerized stream from said liquid hydroisomerized stream;
hydrocracking a hydrocracking charge stream in the presence of hydrogen to provide a hydrocracked stream;
separating said hydrocracked stream in a hydrocracking separator to provide a vaporous hydrocracked stream and a liquid hydrocracked stream;
taking a fractionator hydrocracked stream from said liquid hydrocracked stream;
feeding said fractionator hydroisomerized stream to a product fractionation column; and
feeding said fractionator hydrocracked stream to said product fractionation column.

12. The process of claim 11 wherein said hydroisomerization charge stream is a biorenewable stream.

13. The process of claim 11 further comprising cooling said liquid hydroisomerized stream to provide a cooled liquid hydroisomerized stream and separating a cooled liquid hydroisomerized stream into a cold vaporous hydroisomerized stream and a cold liquid hydroisomerized stream and taking said fractionator hydroisomerized stream from said cold liquid hydroisomerized stream.

14. The process of claim 13 further comprising mixing said vaporous hydrocracked stream with said liquid hydroisomerized stream.

15. The process of claim 14 further comprising stripping a stripper hydroisomerized stream taken from said cold liquid hydroisomerized stream to provide said fractionator hydroisomerized stream and stripping a stripper hydrocracked stream taken from said liquid hydrocracked stream to provide said fractionator hydrocracked stream.

16. The process of claim 14 further comprising stripping a stripper hydroisomerized stream taken from said cold liquid hydroisomerized stream to provide said fractionator hydroisomerized stream and flashing said liquid hydrocracked stream to provide said fractionator hydrocracked stream.

17. The process of claim 11 further comprising hydrotreating a hydrocarbon stream to provide a hydrotreated stream and separating said hydrotreated stream to provide a vaporous hydrotreated stream and a liquid hydrotreated stream and taking said hydroisomerization charge stream from said liquid hydrotreated stream.

18. A process for hydroprocessing a biorenewable feed stream comprising:
hydroisomerizing a hydroisomerization charge stream in the presence of hydrogen over a hydroisomerization catalyst to provide a hydroisomerized stream;
hydrocracking a hydrocracking charge stream in the presence of hydrogen to provide a hydrocracked stream;
separating a liquid hydroisomerized stream from said hydroisomerized stream;
separating a liquid hydrocracked stream from said hydrocracked stream that is separate from said liquid hydroisomerized stream;
feeding said liquid hydroisomerized stream to a product fractionation column; and
feeding said liquid hydrocracked stream to said product fractionation column.

19. The process of claim 18 further comprising stripping a stripper hydroisomerized stream taken from said hydroisomerized stream to provide said liquid hydroisomerized stream and stripping a stripper hydrocracked stream taken from said hydrocracked stream to provide said liquid hydrocracked stream separately from stripping said stripper hydroisomerized stream.

20. The process of claim 18 further comprising stripping a stripper hydroisomerized stream taken from said hydroisomerized stream to provide said liquid hydroisomerized stream and flashing a flash liquid stream taken from said hydrocracked stream to provide said liquid hydrocracked stream separately from stripping said stripper hydroisomerized stream.
